(19) United States
(12) Patent Application Publication
(10) Pub. No.: US 2020/0370762 A1
(43) Pub. Date: Nov. 26, 2020

(54) GRAPHENE HEATING ELEMENT

(71) Applicant: Huanuan (Wuxi) Technology Co., Ltd., Wuxi (CN)

(72) Inventors: Chunzheng ZHANG, Wuxi (CN); Qianqian YANG, Wuxi (CN); Zhijie SHI, Wuxi (CN)

(21) Appl. No.: 16/991,719

(22) Filed: Aug. 12, 2020

(30) Foreign Application Priority Data
Dec. 16, 2019 (CN) 201911291759.9

(51) Int. Cl. F24D 13/02; H05B 3/14; H05B 3/18; H05B 3/20; H05B 3/03

(52) U.S. Cl. CPC F24D 13/024; H05B 3/145; H05B 3/03; H05B 3/20; H05B 3/18

(57) ABSTRACT

Disclosed is a graphene heating element including a box body, a cover body provided on the box body, and a graphene heating chip provided in the box body; wherein a thermal insulation material is injected into the box body and foams so that the graphene heating chip is bonded to the cover body and the box body as a whole. The thermal insulation material foams around and below the graphene heating chip so that the graphene heating chip is adhered to the cover body and the bottom of the box body.

### FIELD OF TECHNOLOGY

This invention relates to a heating element, in particular to a graphene heating element.

### BACKGROUND

Underfloor heating is the abbreviation of radiant floor heating. It is divided according to the thermal media into two categories: water underfloor heating and electric underfloor heating. Graphene electric floor heating is a kind of electric floor heating.

Nowadays, for the current electric heating floor, a heating chip is a usually placed directly under a marble or tile floor, and the heating chip is energized to release energy to heat up a room. There are some problems when using heating floors in such a manner: during transportation or construction, the upper surface of the heating chip is likely to be damaged due to stepping on by the construction personnel, and the bottom surface is likely to be pierced by hard grains of sand, causing damage to the heating chip. Therefore, leakage occurs when the heating chip is energized due to conduction with the ground, which causes a leakage switch to trip, thereby causing the underfloor heating to fail to work normally.

### SUMMARY

Object of the invention: an object of the invention is to provide a graphene heating element formed by integrally bonding a graphene heating chip and an external protection mechanism, which not only prevents the graphene heating chip from being damaged during transportation or when arranging an underfloor heating system, but also avoids a complicated process of layer-by-layer bonding.

Technical solution: a graphene heating element according to the invention including a box body, a cover body provided on the box body, and a graphene heating chip provided in the box body; wherein a thermal insulation material is injected into the box body and foams to form a thermal insulation layer so that the graphene heating chip is bonded to the cover body and the box body as a whole.

Preferably, the thermal insulation material is injected into the box body and foams around and below the graphene heating chip, so that the graphene heating chip is respectively adhered to the cover body and the bottom of the box body.

Preferably, a support body for supporting the graphene heating chip is provided in the box body, so as to press the graphene heating chip against the cover body.

Preferably, an injection port for the thermal insulation material is provided on the box body.

Preferably, a positive electrode and a negative electrode are provided on the graphene heating chip; in order to facilitate the use of a plurality of graphene heating elements in series, a first connection line and a second connection line are provided in the box body, the first connection line and the second connection line are respectively connected at one end to the positive electrode and the negative electrode, and respectively extend out of the box body at the other end for connecting to a power supply or a connection line of another graphene heating element.

Preferably, a first connector and a second connector are respectively mounted at extending-out ends of the first connection line and the second connection line, and the first connector can be inserted into the second connector. When a plurality of graphene heating elements are needed to be used, the first connector of a graphene heating element is connected to the second connector of another graphene heating element.

Preferably, grooves are provided on both sides of the box body, which are used to place the first connector and the second connector.

Preferably, a projection for placing and fixing the connection line is provided on the inside of the box body.

In order to increase the heat transfer of the graphene heating chip in the box body to the outside through the cover body, the cover body is made of a thermally conductive material.

Preferably, the box body is made of a hard material.

Preferably, a positive electrode and a negative electrode are provided on the graphene heating chip, and a socket is welded to the positive electrode and the negative electrode.

Preferably, a socket opening for the socket is provided on the box body.

Preferably, a reinforcing rib is provided on the inner surface of the box body.

Preferably, the thermal insulation material includes at least one of polyurethane, polystyrene, phenolic, rubber and plastic, and an inorganic foam material. More preferably, the thermal insulation material includes a polyurethane foam material.

Beneficial effects: compared with the prior art, the present invention has the following beneficial effects: 1. the graphene heating chip is integrally bonded to the external box body structure by using on-site foaming of the thermal insulation foam material, thereby not only preventing the graphene heating chip from being damaged during transportation or when arranging an underfloor heating system, but also avoiding a complicated process of layer-by-layer bonding; 2. since the thermal insulation foam material foams and is formed in the entire box body, a separate insulation treatment for a welding point can be avoided; 3. the use of the thermal insulation foam material to replace existing adhesives and other bonding materials for bonding is beneficial to environmental protection; 4. the cover body is made of the thermal insulation material, guaranteeing the heat generation and heat transfer performance of the graphene heating chip while greatly improving the safety of the graphene heating element; 5. two connection lines are provided on the graphene heating element, facilitating the use of a plurality of graphene heating elements in series; 6. connectors are provided on the extending-out ends of the two connection lines, protecting the conductive wires on the one hand, and facilitating the series connection among different connectors on the other hand.

### BRIEF DESCRIPTION OF THE DRAWINGS

FIG. 1 is a schematic diagram of the overall structure according to the invention;

FIG. 2 is a schematic diagram of the internal structure according to the invention;

FIG. 3 is a schematic cross-sectional view of the overall structure according to the invention;

FIG. 4 is a schematic diagram of a deformation of the overall structure according to the invention;

FIG. 5A is a schematic diagram of the structure of the first connection line;

FIG. 5B is a schematic diagram of the structure of the second connection line;

FIG. 6 is a schematic diagram of the outer surface of the box body in FIG. 4;

FIG. 7 is a schematic diagram of the inner surface of the box body in FIG. 4.

### DETAILED DESCRIPTION OF THE EMBODIMENTS

The technical solutions of the present invention will be further described below in conjunction with the drawings and specific embodiments.

As shown in FIGS. 1-3, wherein, 1—cover body, 2—graphene heating chip, 3—socket, 4—thermal insulation material, 5—box body, 6—injection port, 7—socket opening. A graphene heating element according to the invention includes a box body 5 and a cover body 1 on the box body 5. The box body 5 and the cover body 1 are preferably made of a hard material. The cover body 1 is made of a thermal insulation material, further facilitating to increase the heat transfer of the graphene heating chip 5 inside the box body 5 to the outside. The box body 5 may be designed into various shapes as required, and in this embodiment is square. In order to prevent corners from being bumped during transportation and installation, the four corners of the box body 5 in this embodiment are all rounded.

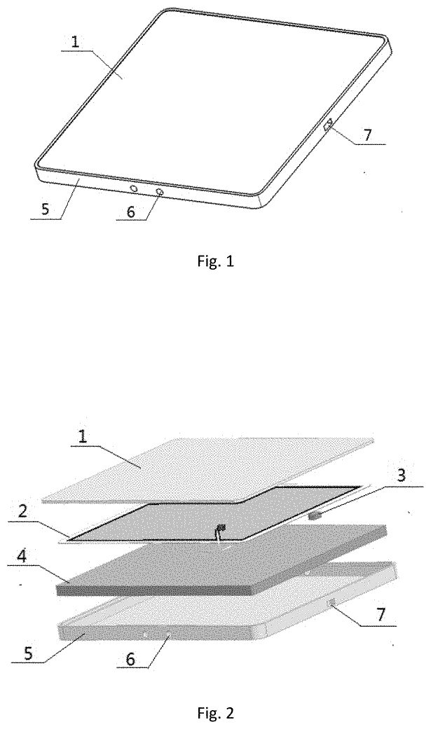

As shown in FIG. 2, a graphene heating chip 2 is placed in the box body 5. The graphene heating chip 2 is the core structure, used for heating, of the entire graphene heating module. In order to press the graphene heating chip 2 against the cover body 1 and leave a gap between the graphene heating chip and the bottom of the box body 5, a bracket (not shown in the figure) for supporting the graphene heating chip 2 is placed in the box body 5. Other support bodies capable of supporting the graphene heating chip 2 may also be provided, as long as the graphene heating chip 2 and the cover body 1 can be pressed against each other. A positive electrode and a negative electrode are provided on the graphene heating chip 2. A socket 3 used for connecting to a power line in series is welded on the positive electrode and the negative electrode of the graphene heating chip 2, and the welding portions may be sealed with a glue. A preset socket opening 7 corresponding to the socket 3 is provided on a side of the box body 5 so as to connect to a conductive wire on the outside.

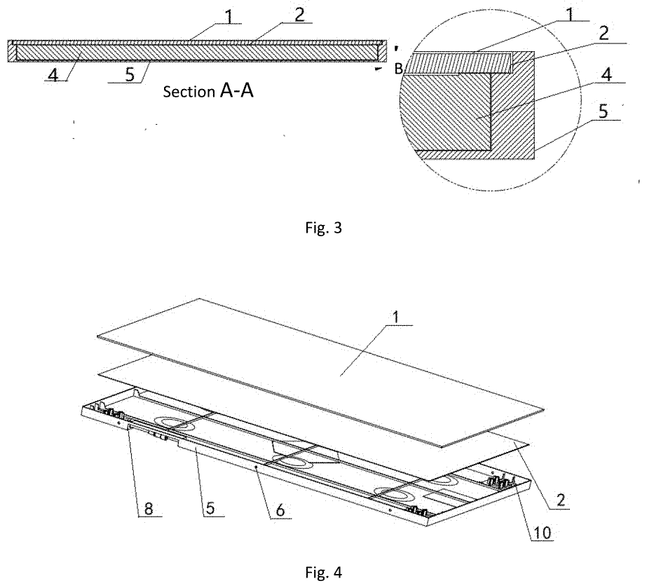

In order to facilitate the injection of the thermal insulation foam material into the box body 5, two injection ports 6 are respectively provided on the two sides of the box body 5. The thermal insulation material 4 in this embodiment is a polyurethane foam material, whereas the thermal insulation foam material 4 may also be polystyrene, phenolic, rubber and plastic, inorganic foam material or a combination thereof. The thermal insulation foam material 4 is injected into the box 5 through the injection port 6 and foams in the box 5 on site. Since the graphene heating chip 2 is pressed against the cover body 1 and there is a gap between the graphene heating chip and the bottom of the box body 5, the injected thermal insulation foam material 4 foams around and below the graphene heating chip 2, and the graphene heating chip 2 is bonded to the cover body 1 and the box body 5 as a whole by the thermal insulation foam material on the side of and below the graphene heating chip. The foaming of the thermal insulation foam material 4 inside the entire box body 5 also causes the thermal insulation foam material 4 to be filled at the welding portions of the graphene heating chip 2, which has the effect of insulation and does not require any other insulation protection. The welding portions may also be sealed with a glue first, and then filled with the foam material. In this embodiment, since there is no thermal insulation foam material between the graphene heating chip 2 and the cover body 1, the graphene heating chip 2 can transfer heat to the outside through the cover body 1 in a better way, while the rest of the space is filled with the thermal insulation foam material to form a thermal insulation layer. As shown in FIG. 3, the oblique line part is an area filled with the thermal insulation foam material 4, and the circled part is an enlarged view of partial areas. On the one hand, the thermal insulation layer has a thermal insulation effect, on the other hand, it avoids a complicated process of the prior art in which the graphene heating chip 2 is required to be bonded to other members layer by layer, and also avoids the use of an adhesive for bonding, which is beneficial to environmental protection. Moreover, it avoids separate insulation protection treatment for the welding points of the socket 3. According to the invention, the graphene heating element is a whole in which the graphene heating chip is sealed, therefore, the chip can be effectively isolated from cement mortar to avoid erosion of the chip by the alkalinity of the cement, thereby greatly increasing the safety of the graphene heating module.

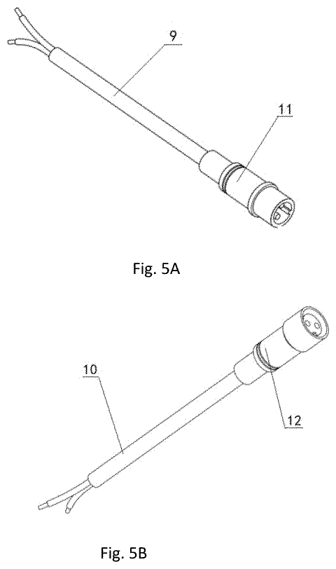

As shown in FIG. 4, the graphene heating element may also have the structure in FIG. 4. As shown in FIG. 5(a) and FIG. 5(b), a first connection line 9 and a second connection line 10 are provided in the box body 5, both of which are used to connect the graphene heating chip and the power line. The first connection line and the second connection line are respectively composed of a red conductive wire and a blue conductive wire wrapped by a cable. The red conductive wire and the blue conductive wire are respectively connected at one end to the positive electrode and the negative electrode on the graphene heating chip 2, and are respectively fixed at the other end with a first connector 11 and a second connector 12. The connector is a waterproof connector that is commercially available. On the one hand, the connector play a role of protecting the conductive wire, on the other hand, when two or more graphene heating elements are needed, the first connector 11 on one graphene heating element can be connected in series to the second connector 12 on the other graphene heating element. Since there are two connection lines on each graphene heating element, a plurality of graphene heating elements can be connected in series.

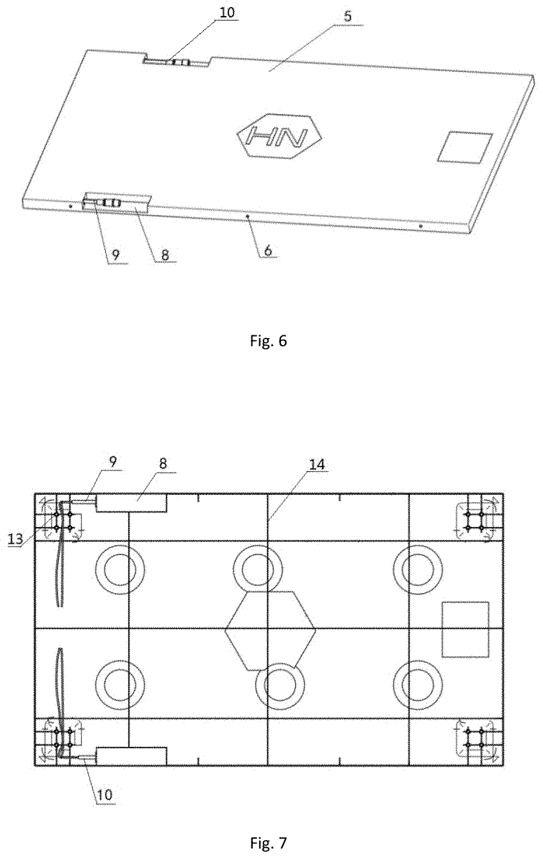

As shown in FIG. 6, grooves 8 are provided on two opposite sides of the box body 5 of the grapheme heating body. The extending-out ends of the first connection line 9 and the second connection line 10 pass out from one side of the grooves 8 so that the first connector 11 and the second connector 12 respectively extend into the grooves 8.

As shown in FIG. 7, two corners of the box body 5 are respectively provided with a projection 13 for placing and fixing the connection line, and the inner surface of the box body 5 is provided with reinforcing ribs 14 for increasing the strength of the box body.

What is claimed is:

1. A graphene heating element, comprising a box body (5), a cover body (1) provided on the box body (5), and a graphene heating chip (2) provided in the box body (5); wherein a thermal insulation material (4) is injected into the box body (5) and foams so that the graphene heating chip (2) is bonded to the cover body (1) and the box body (5) as a whole.

2. The graphene heating element according to claim 1, wherein the thermal insulation material (4) is injected into the box body (5) and foams around and below the graphene heating chip (2).

3. The graphene heating element according to claim 1, wherein a support body for supporting the graphene heating chip (2) is provided in the box body (5), so as to press the graphene heating chip (2) against the cover body (1).

4. The graphene heating element according to claim 1, wherein an injection port (6) for the thermal insulation material (4) is provided on the box body (5).

5. The graphene heating element according to claim 1, wherein a positive electrode and a negative electrode are provided on the graphene heating chip (2), a first connection line (9) and a second connection line (10) are provided in the box body (5), the first connection line (9) and the second connection line (10) are respectively connected at one end to the positive electrode and the negative electrode, and respectively extend out of the box body (5) at the other end.

6. The graphene heating element according to claim 5, wherein a first connector (11) and a second connector (12) are respectively mounted at extending-out ends of the first connection line (9) and the second connection line (10), and the first connector (11) can be inserted into the second connector (12).

7. The graphene heating element according to claim 1, wherein grooves (8) are provided on both sides of the box body (5).

8. The graphene heating element according to claim 5, wherein projections for placing and fixing the first connection line (9) and the second connection line (10) are respectively provided on the inner surface of the box body (5).

9. The graphene heating element according to claim 1, wherein a positive electrode and a negative electrode are provided on the graphene heating chip (2), and a socket (3) is welded to the positive electrode and the negative electrode.

10. The graphene heating element according to claim 9, wherein a socket opening (7) for the socket (3) is preset on the box body (5).
